(19) United States
(12) Patent Application Publication
(10) Pub. No.: US 2023/0121241 A1
(43) Pub. Date: Apr. 20, 2023

(54) SYSTEM AND METHOD OF UTILIZING A KEYBOARD WITH A DISPLAY

(71) Applicant: Dell Products L.P., Round Rock, TX (US)

(72) Inventors: Andrew Fausak, Colleyville, TX (US); Uboho Thomas Victor, San Antonio, TX (US)

(21) Appl. No.: 17/451,522

(22) Filed: Oct. 20, 2021

(51) Int. Cl. G06F 3/0488; G06F 3/02

(52) U.S. Cl. CPC G06F 3/04886; G06F 3/0227

(57) ABSTRACT

In one or more embodiments, one or more systems, one or more methods, and/or one or more processes may provide, by a first application executed by an information handling system (IHS), configuration information to a keyboard; configure, by the keyboard, a display of the keyboard with a graphic based at least on the configuration information; receive, by the keyboard, first user input associated with the graphic; provide, by the keyboard, first keyboard information to the IHS; provide, by the IHS, the first keyboard information to a second application executed by the IHS; receive, by the first application, second user input; provide, by the first application, information based at least on the second user input to the keyboard; provide, by the keyboard to the IHS, second keyboard information based at least on the information; and provide, by the IHS, the second keyboard information to the second application.

### BACKGROUND

### Field of the Disclosure

This disclosure relates generally to information handling systems and more particularly to utilizing a keyboard with a display.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, one or more methods, and/or one or more processes may provide, by a first application executed by a first processor of an information handling system via a first coupling, configuration information to a second processor of a keyboard associated with the information handling system; may configure, by a second application executed by the second processor, a display of the keyboard with at least one graphic based at least on the configuration information; may receive, by the second processor, first user input associated with the at least one graphic; may provide, by the second processor via a second coupling, first keyboard information to the first processor; may provide, by the first processor, the first keyboard information to a third application executed by the first processor that has user input focus; may receive, by the first application, second user input; may provide, by the first application via the first coupling, information based at least on the second user input to the second processor; may process, by the second processor, the information to determine second keyboard information; may provide, by the second processor, the second keyboard information to the first processor via the second coupling; and may provide, by the first processor, the second keyboard information to the third application executed by the first processor that has the user input focus.

In one or more embodiments, the first application may not have the user input focus. In one or more embodiments, providing the information based at least on the second user input to the second processor may include providing the information to the second processor without providing the information to an operating system executing on the information handling system. In one or more embodiments, the first user input may include at least one of a selection of the at least one graphic and a swipe of the at least one graphic. In one or more embodiments, the information handling system may be at least one of a laptop-type information handling system and a notebook-type information handling system, among others. In one or more embodiments, the first coupling may include at least one of a first inter-integrated circuit (I²C) bus, a first serial peripheral interface (SPI) bus, a first low pin count (LPC) bus, a first enhanced serial peripheral interface (eSPI) bus, a first universal serial bus (USB), and a first system management bus (SMBus). For example, the second coupling may include at least one of a second I²C bus, a second SPI bus, a second LPC bus, a second eSPI bus, a second USB, and a second SMBus. For instance, the second coupling may be different from the first coupling.

In one or more embodiments, a keyboard associated with an information handling system may include a first processor; a display communicatively coupled to the first processor; and a memory medium, coupled to the first processor, that stores instructions executable by the first processor, which when executed by the first processor, may cause the keyboard to: receive, via a first coupling, configuration information from a first application executed by a second processor of an information handling system; configure the display with at least one graphic based at least on the configuration information; receive first user input associated with the at least one graphic; provide, via a second coupling, first keyboard information to the second processor, which provides the first keyboard information to a second application executed by the second processor that has user input focus; receive, via the first coupling, information based at least on second user input received by the second processor via the first application; process the information to determine second keyboard information; and provide the second keyboard information to the second processor via the second coupling, which provides the second keyboard information to the second application executed by the second processor that has the user input focus.

In one or more embodiments, the second coupling may be different from the first coupling. In one or more embodiments, the first user input may include at least one of a selection of the at least one graphic and a swipe of the at least one graphic. In one or more embodiments, the information handling system may include the keyboard. For example, the information handling system may be at least one of a laptop-type information handling system and a notebook-type information handling system, among others. In one or more embodiments, the first coupling may include at least one of a first I²C bus, a first SPI bus, a first LPC bus, a first eSPI bus, a first USB, and a first SMBus; and the second coupling may include at least one of a second I²C bus, a second SPI bus, a second LPC bus, a second eSPI bus, a second USB, and a second SMBus. In one or more embodiments, the keyboard may include a microcontroller. For example, the microcontroller may include the first processor of the keyboard and the memory medium of the keyboard.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1A illustrates an example of an information handling system, according to one or more embodiments;

FIG. 1B illustrates a second example of an information handling system, according to one or more embodiments;

FIG. 1C illustrates a third example of an information handling system, according to one or more embodiments;

FIG. 1D illustrates a fourth example of an information handling system, according to one or more embodiments;

FIG. 1E illustrates another example of an information handling system, according to one or more embodiments;

FIG. 2 illustrates an example of an embedded controller, according to one or more embodiments;

FIG. 3A illustrates an example of a logical representation of communications associated with an adaptive row, according to one or more embodiments;

FIG. 3B illustrates an example of a microcontroller, according to one or more embodiments;

FIG. 3C illustrates an example of software stacks, according to one or more embodiments;

FIGS. 4A and 4B illustrates an example of utilizing an adaptive row, according to one or more embodiments;

FIG. 4C illustrates a second example of utilizing an adaptive row, according to one or more embodiments;

FIG. 4D illustrates a third example of utilizing an adaptive row, according to one or more embodiments;

FIG. 4E illustrates a fourth example of utilizing an adaptive row, according to one or more embodiments;

FIG. 4F illustrates another example of utilizing an adaptive row, according to one or more embodiments

FIG. 5 illustrates an example of a sequence diagram of utilizing an adaptive row, according to one or more embodiments;

FIG. 6 illustrates an example of a method of utilizing an adaptive row with an information handling system, according to one or more embodiments;

FIG. 7A illustrates an example of a method of operating a keyboard, according to one or more embodiments; and

FIG. 7B illustrates an example of a method of operating an adaptive row, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a keyboard associated with an information handling system may include an adaptive row. For example, the adaptive row (e.g., a touch screen) may contextually adapt based at least on user interactions. For instance, the user interactions may dynamically change the adaptive row and an on screen display (OSD), which may be displayed via a display associated with the information handling system. In one or more embodiments, the adaptive row may enhance a top row of the keyboard with haptic feedback and an application, which may provide an OSD for feedback. For example, the adaptive row may provide value for users needing specialized functions and/or task controls that are readily accessible as a seamless and/or intuitive user interface.

In one or more embodiments, the adaptive row may provide one or more modern-type interactions with computing equipment. While modern-type interactions may follow natural behaviors and may be intuitive and uncluttered, some of the computer interactions (e.g., changing an operating system/application setting) may require multiple steps and/or take focus away from a task at hand. For example, the adaptive row may provide a faster, more efficient workflow, which may put what a user needs at the fingertips of the user.

In one or more embodiments, a keyboard may send key events to an information handling system in response to user keyboard input. In a case of complex dynamic keys (e.g., a touch-bar or adaptive-row) key codes and/or actions may change for a key-slot as a function of a menu or label changing set of rules. For example, when actions may extend to other surfaces, such as an application (not contained within the keyboard) generating OSD, a means to interpret by application and send via standard keyboard convention is desired. For example, no matter where a user event requires key event, that event may be programmatically defined and sent via an information handling system keyboard port (e.g., a keyboard host port) by sending through a supported interface allowing a “pass through” syntax. Until now, an application today may not send a key through a keyboard information handling system port (e.g., a keyboard host port).

In one or more embodiments, an adaptive row may specialize a keyboard with one or more rows of keys having redefinition capability. For example, a key position, a key legend, and a key operation may be defined programmatically through a persistent definition in a file system within the keyboard. For instance, access to the file system may occur through a composite device definition of storage class device within the keyboard. In one or more embodiments, a data structure may be provided in such a manner that a processor of the keyboard may read files describing placement of keys (e.g., x-y coordinates), legends, colors, and/or sub-menus to select a specific selection method defined in the same configuration files.

In one or more embodiments, an operation of an adaptive row may include use of an application simulating an OSD that may permit a user to view a bar of symbols representative of an entire row over which fingers may be hovering. For example, when a finger hovers over an adaptive row, an OSD may be displayed via a display (e.g., “pops up”) showing the entire row of keys available at a middle of the display. For instance, a specific key that is being selected may be enlarged (e.g., ballooned) to indicate that a user can select the key by actuating (e.g., depressing, tapping, etc.) the specific key that is being hovered.

In one or more embodiments, an adaptive row may include an ability to send key events using an alternate port as a result of a syntactic command, rather than an actuation (e.g., depression, touching, etc.) of a region on or within an actual key field. For example, this may enable external events (e.g., those not within view of the keyboard's implementation) to provide key event when meeting definition requirements. For instance, an adaptive row equipped with touch screen capabilities, the touch region included within an OSD field may be actuated (e.g., depressed) and a key event may be invoked by use of an alternate port providing syntactic command capability to the keyboard to send key code as if the key was invoked on the keyboard as a result of selection of a key within the OSD field, rather than the adaptive row key field. As an example, this alternate port extension may enable applications in an operating system domain and/or an operating system context to operate as if the applications were operating in the keyboard.

In one or more embodiments, an application may extend hardware of a keyboard that includes an adaptive row. For example, the application may extend one or more capabilities of firmware of the keyboard that includes an adaptive row. For instance, the application may include one or more capabilities the keyboard that includes an adaptive row. In one or more embodiments, any input surface of an information handling system may be utilized to extend a keyboard. For example, any input surface of an information handling system, which can be configured to receive user input, may utilized in providing one or more hardware keyboard events to an operating system and/or an application. For instance, any input surface of an information handling system, which can be configured to receive user input, may utilized as an extension of a keyboard. In one or more embodiments, an application may provide information to a keyboard. For example, the keyboard may process the information. For instance, the keyboard may provide a keyboard event (e.g., a hardware event) to an information handling system based at least on processing the information from the application.

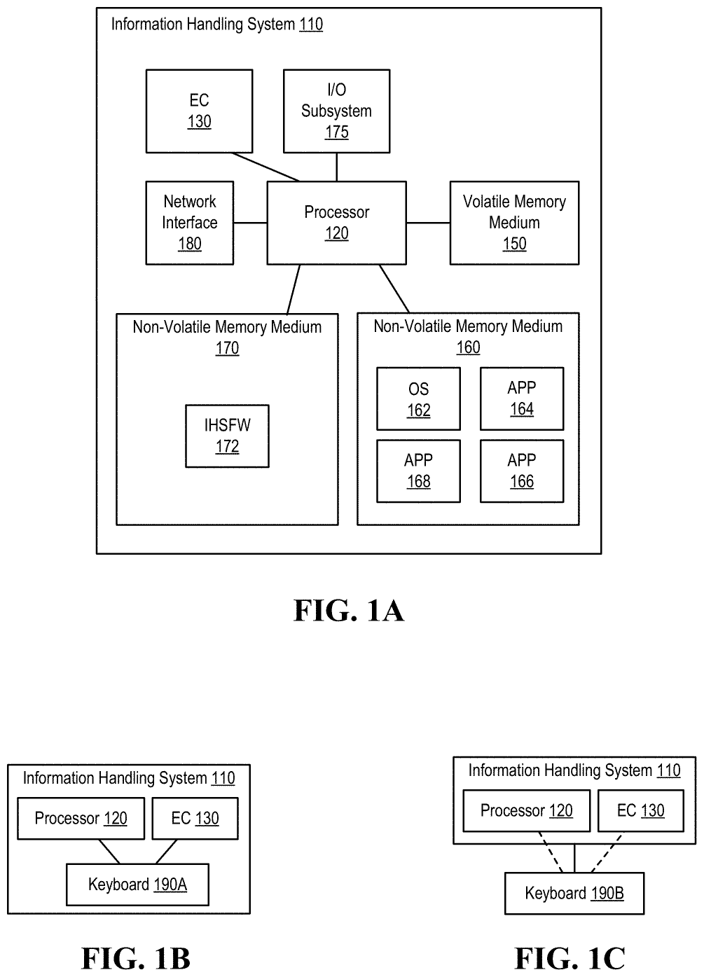

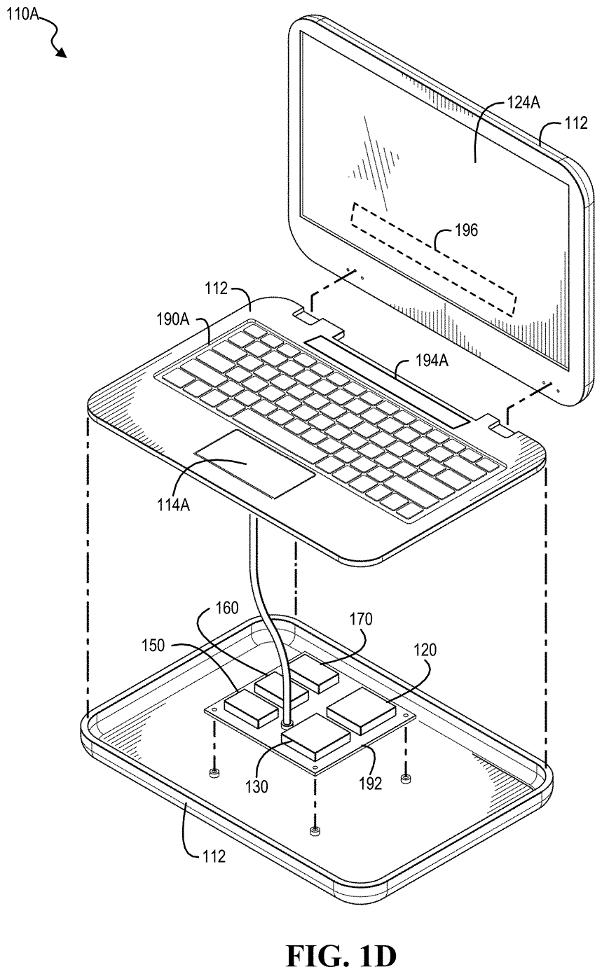

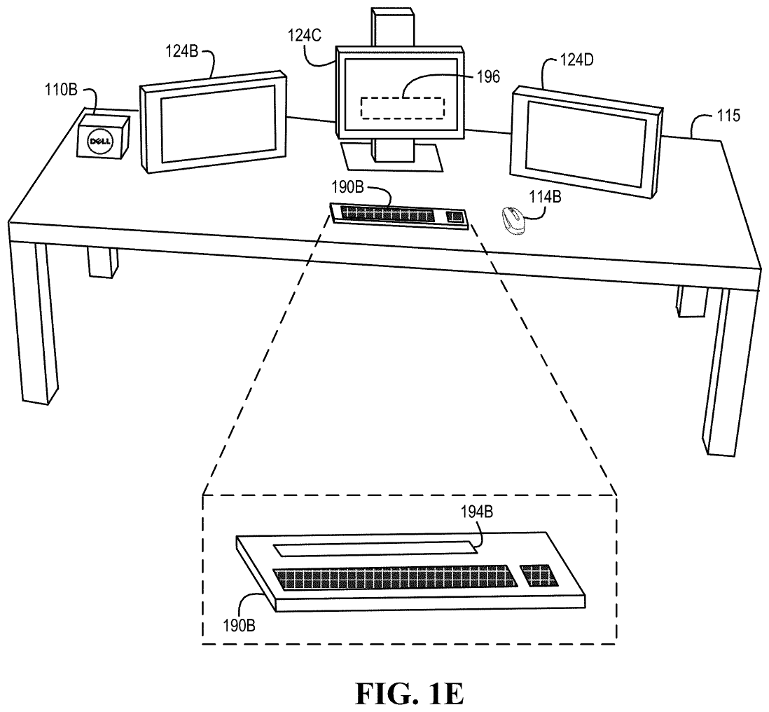

Turning now to FIG. 1A, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, an embedded controller (EC) 130, a volatile memory medium 150, non-volatile memory media 160 and 170, an I/O subsystem 175, and a network interface 180. As illustrated, EC 130, volatile memory medium 150, non-volatile memory media 160 and 170, I/O subsystem 175, and network interface 180 may be communicatively coupled to processor 120.

In one or more embodiments, one or more of EC 130, volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of EC 130, volatile memory medium 150, non-volatile memory media 160 and 170, I/O subsystem 175, and network interface 180 may be communicatively coupled to processor 120 via one or more PCI-Express (PCIe) root complexes. In another example, one or more of EC 130, I/O subsystem 175, and network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network. In one instance, the wireless network may include a cellular telephone network. In a second instance, the wireless network may include a satellite telephone network. In another instance, the wireless network may include a wireless Ethernet network (e.g., a Wi-Fi network, an IEEE 802.11 network, etc.).

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing at least a portion of one or more systems, at least a portion of one or more flowcharts, at least a portion of one or more methods, and/or at least a portion of one or more processes described herein. In one example, processor 120 may execute processor instructions from one or more of memory media 150, 160, and 170 in implementing at least a portion of one or more systems, at least a portion of one or more flowcharts, at least a portion of one or more methods, and/or at least a portion of one or more processes described herein. In another example, processor 120 may execute processor instructions via network interface 180 in implementing at least a portion of one or more systems, at least a portion of one or more flowcharts, at least a portion of one or more methods, and/or at least a portion of one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150, 160, and 170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, OS 162 may include a management information exchange. In one example, the management information exchange may permit multiple components to exchange management information associated with managed elements and/or may permit control and/or management of the managed elements. In another example, the management information exchange may include a driver and/or a driver model that may provide an OS interface through which managed elements (e.g., elements of IHS 110) may provide information and/or notifications, among others. In one instance, the management information exchange may be or include a Windows Management Interface (WMI) for ACPI (available from Microsoft Corporation). In another instance, the management information exchange may be or include a Common Information Model (CIM) (available via the Distributed Management Task Force). In one or more embodiments, the management information exchange may include a combination of the WMI and the CIM. For example, WMI may be and/or may be utilized as an interface to the CIM. For instance, the WMI may be utilized to provide and/or send CIM object information to OS 162.

In one or more embodiments, processor 120 and one or more components of IHS 110 may be included in a system-on-chip (SoC). For example, the SoC may include processor 120 and a platform controller hub (not specifically illustrated).

In one or more embodiments, EC 130 may be or include a remote access controller. For example, the remote access controller may be or include a DELL™ Remote Access Controller (DRAC). In one or more embodiments, a remote access controller may be integrated into IHS 110. For example, the remote access controller may be or include an integrated DELL™ Remote Access Controller (iDRAC). In one or more embodiments, a remote access controller may include one or more of a processor, a memory, and a network interface, among others. In one or more embodiments, a remote access controller may access one or more busses and/or one or more portions of IHS 110. For example, the remote access controller may include and/or may provide power management, virtual media access, and/or remote console capabilities, among others, which may be available via a web browser and/or a command line interface. For instance, the remote access controller may provide and/or permit an administrator (e.g., a user) one or more abilities to configure and/or maintain an information handling system as if the administrator was at a console of the information handling system and/or had physical access to the information handling system.

In one or more embodiments, a remote access controller may interface with baseboard management controller integrated circuits and/or may interface with embedded controller integrated circuits. In one example, the remote access controller may be based at least on an Intelligent Platform Management Interface (IPMI) standard. For instance, the remote access controller may allow and/or permit utilization of IPMI out-of-band interfaces such as IPMI Over LAN (local area network). In another example, the remote access controller may be based at least on a Redfish standard. In one instance, one or more portions of the remote access controller may be compliant with one or more portions of a Redfish standard. In another instance, one or more portions of the remote access controller may implement one or more portions of a Redfish standard. In one or more embodiments, a remote access controller may include and/or provide one or more internal private networks. For example, the remote access controller may include and/or provide one or more of an Ethernet interface, a front panel USB interface, and a Wi-Fi interface, among others. In one or more embodiments, a remote access controller may be, include, or form at least a portion of a virtual KVM (keyboard, video, and mouse) device. For example, a remote access controller may be, include, or form at least a portion of a KVM over IP (IPKVM) device. For instance, a remote access controller may capture video, keyboard, and/or mouse signals; may convert the signals into packets; and may provide the packets to a remote console application via a network.

In one or more embodiments, EC 130 may be or include a microcontroller. For example, the microcontroller may be or include an 8051 microcontroller, an ARM Cortex-M (e.g., Cortex-M0, Cortex-M1, Cortex-M3, Cortex-M4, Cortex-M7, etc.) microcontroller, a MSP430 microcontroller, an AVR (e.g., 8-bit AVR, AVR-32, etc.) microcontroller, a PIC microcontroller, a 68HC11 microcontroller, a ColdFire microcontroller, and a Renesas microcontroller, among others. In one or more embodiments, EC 130 may be or include an application processor. In one example, EC 130 may be or include an ARM Cortex-A processor. In another example, EC 130 may be or include an Intel Atom processor. In one or more embodiments, EC 130 may be or include one or more of a field programmable gate array (FPGA) and an ASIC, among others, configured, coded, and/or encoded with instructions in accordance with at least a portion of one or more of systems, at least a portion of one or more flowcharts, at least a portion of one or more methods, and/or at least a portion of one or more processes described herein.

Turning now to FIG. 1B, a second example of an information handling system is illustrated, according to one or more embodiments. In one or more embodiments, an information handling system may include a keyboard. For example, IHS 110 may include a keyboard 190A. In one instance, keyboard 190A may be communicatively coupled to processor 120. In another instance, keyboard 190A may be communicatively coupled to EC 130.

Turning now to FIG. 1C, a third example of an information handling system is illustrated, according to one or more embodiments. In one or more embodiments, an information handling system may be communicatively coupled to a keyboard. For example, the keyboard may be external to the information handling system. For instance, IHS 110 may be communicatively coupled to a keyboard 190B. For instance, keyboard 190B may be external to IHS 110. As one example, keyboard 190B may be communicatively coupled to processor 120. As another example, keyboard 190B may be communicatively coupled to EC 130.

Turning now to FIG. 1D, a fourth example of an information handling system is illustrated, according to one or more embodiments. In one or more embodiments, an IHS 110A may be a portable information handling system, which may be configured to be carried by a user. In one example, IHS 110A may be a laptop-type information handling system. In another example, IHS 110A may be a notebook-type information handling system. In one or more embodiments, IHS 110A may include a chassis 112 (e.g., a housing). In one example, IHS 110A may include a motherboard 192. For instance, chassis 112 may house motherboard 192. In a second example, IHS 110A may include keyboard 190A. For instance, chassis 112 may house keyboard 190A. In a third example, IHS 110A may include an adaptive row 194A. For instance, chassis 112 may house adaptive row 194A. In another example, IHS 110A may include a display 124A. For instance, chassis 112 may house display 124A. Although not specifically illustrated, display 124A may be communicatively coupled to processor 120 of IHS 110A, according to one or more embodiments. In one or more embodiments, IHS 110A may include a pointing device 114A. For example, pointing device 114A may be or may include a touchpad. In one or more embodiments, pointing device 114A may be utilized by a user to move a cursor and/or a pointer of a graphical user interface (GUI). In one or more embodiments, display 124A may display an OSD 196. For example, OSD 196 may mirror one or more images and/or one or more graphics of adaptive row 194A.

Turning now to FIG. 1E, another example of an information handling system is illustrated, according to one or more embodiments. In one or more embodiments, an information handling system may be configured to be stationary. For example, an IHS 110B may be configured to lie on a desk 115. In one or more embodiments, an information handling system may be communicatively coupled to one or more displays. For example, IHS 110B may be communicatively coupled to displays 124B-124D, among others. For instance, processor 120 of IHS 110B may be communicatively coupled to displays 124B-124D, among others. Although displays 124B-124D are illustrated in FIG. 1E, IHS 110B may be communicatively coupled to any number of displays 124, according to one or more embodiments.

In one or more embodiments, IHS 110B may be communicatively coupled to keyboard 190B. In one example, IHS 110B may be communicatively coupled to keyboard 190B in a wired fashion. In another example, IHS 110B may be communicatively coupled to keyboard 190B in a wireless fashion. In one or more embodiments, keyboard 190B may include an adaptive row 194B. In one or more embodiments, IHS 110B may be communicatively coupled to a pointing device 114B. For example, pointing device 114B may be or may include a mouse. In one or more embodiments, pointing device 114B may be utilized by a user to move a cursor and/or a pointer of a GUI. In one instance, pointing device 114B may be communicatively coupled to IHS 110B in a wired fashion. In another instance, pointing device 114B may be communicatively coupled to IHS 110B in a wireless fashion.

In one or more embodiments, a display communicatively coupled to IHS 110B may display OSD 196. For example, display 124C may display OSD 196. For instance, OSD 196 may mirror one or more images and/or one or more graphics of adaptive row 194B. Although not specifically illustrated, any display communicatively coupled to IHS 110B may display OSD 196, according to one or more embodiments. In one example, display 124B may display OSD 196. In another example, display 124D may display OSD 196.

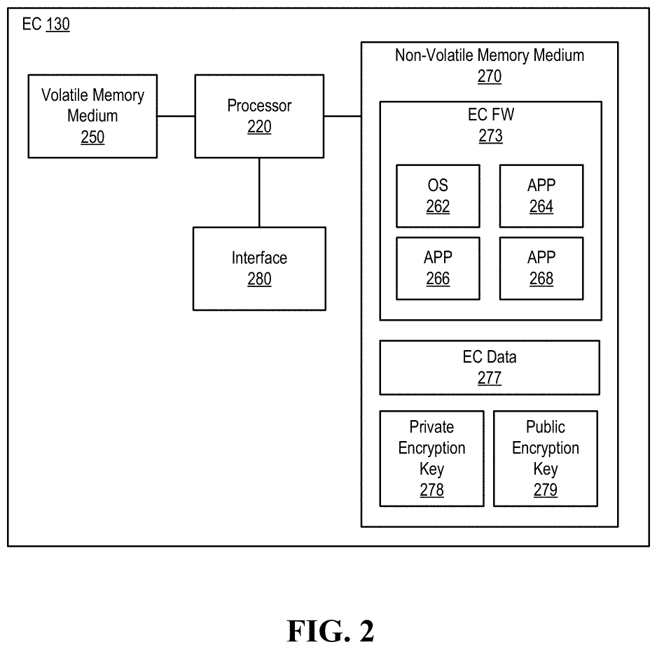

Turning now to FIG. 2, an example of an embedded controller is illustrated, according to one or more embodiments. As shown, EC 130 may include a processor 220, a volatile memory medium 250, a non-volatile memory medium 270, and an interface 280. As illustrated, non-volatile memory medium 270 may include a EC firmware (FW) 273, which may include an OS 262 and APPs 264-268, and may include EC data 277. In one example, OS 262 may be or include a real-time operating system (RTOS). For instance, the RTOS may be or include FreeRTOS, OpenRTOS, SafeRTOS, QNX, ThreadX, VxWorks, NuttX, TI-RTOS, eCos, MicroC/OS, or Zephyr, among others. In a second example, OS 262 may be or include an Unix-like operating system. For instance, the Unix-like operating system may be or include LINUX®, FREEBSD®, NETBSD®, OpenBSD, Minix, Xinu, or Darwin, among others. In another example, OS 262 may be or include a portable operating system interface (POSIX) compliant operating system. As illustrated, non-volatile memory medium 270 may include a private encryption key 278. As shown, non-volatile memory medium 270 may include a public encryption key 279. In one or more embodiments, private encryption key 278 may be different from public encryption key 279. For example, private encryption key 278 and public encryption key 279 may be asymmetric encryption keys. In one instance, data encrypted via private encryption key 278 may be decrypted via public encryption key 279. In another instance, data encrypted via public encryption key 279 may be decrypted via private encryption key 278.

In one or more embodiments, interface 280 may include circuitry that enables communicatively coupling to one or more devices. In one example, interface 280 may include circuitry that enables communicatively coupling to one or more buses. For instance, the one or more buses may include one or more buses described herein, among others. In a second example, interface 280 may include circuitry that enables one or more interrupt signals to be received. In one instance, interface 280 may include general purpose input/output (GPIO) circuitry, and the GPIO circuitry may enable one or more interrupt signals to be received and/or provided via at least one interrupt line. In another instance, interface 280 may include GPIO circuitry that may enable EC 130 to provide and/or receive signals associated with other circuitry (e.g., diagnostic circuitry, etc.). In a third example, interface 280 may include circuitry that enables communicatively coupling to one or more networks. In one instance, interface 280 may include circuitry that enables communicatively coupling to network interface 180. In another example, interface 280 may include a network interface.

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250. In one or more embodiments, processor 220 may execute instructions in accordance with at least a portion of one or more systems, at least a portion of one or more flowcharts, one or more methods, and/or at least a portion of one or more processes described herein. For example, non-volatile memory medium 270 and/or volatile memory medium 250 may store instructions that may be executable in accordance with at least a portion of one or more systems, at least a portion of one or more flowcharts, at least a portion of one or more methods, and/or at least a portion of one or more processes described herein. In one or more embodiments, processor 220 may execute instructions in accordance with at least a portion of one or more of systems, flowcharts, at least a portion of one or more methods, and/or at least a portion of one or more processes described herein. For example, non-volatile memory medium 270 and/or volatile memory medium 250 may store instructions that may be executable in accordance with at least a portion of one or more of systems, at least a portion of one or more flowcharts, at least a portion of one or more methods, and/or at least a portion of one or more processes described herein. In one or more embodiments, processor 220 may utilize EC data 277. In one example, processor 220 may utilize EC data 277 via non-volatile memory medium 270. In another example, one or more portions of EC data 277 may be transferred to volatile memory medium 250, and processor 220 may utilize EC data 277 via volatile memory medium 250.

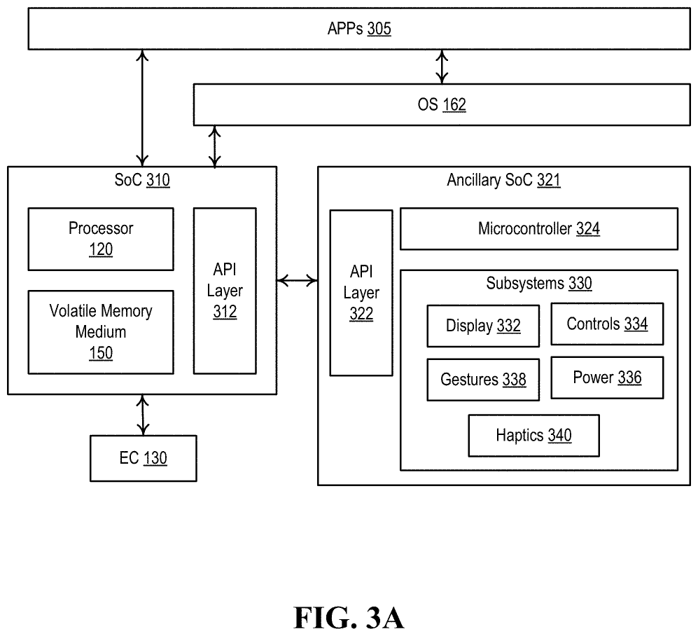

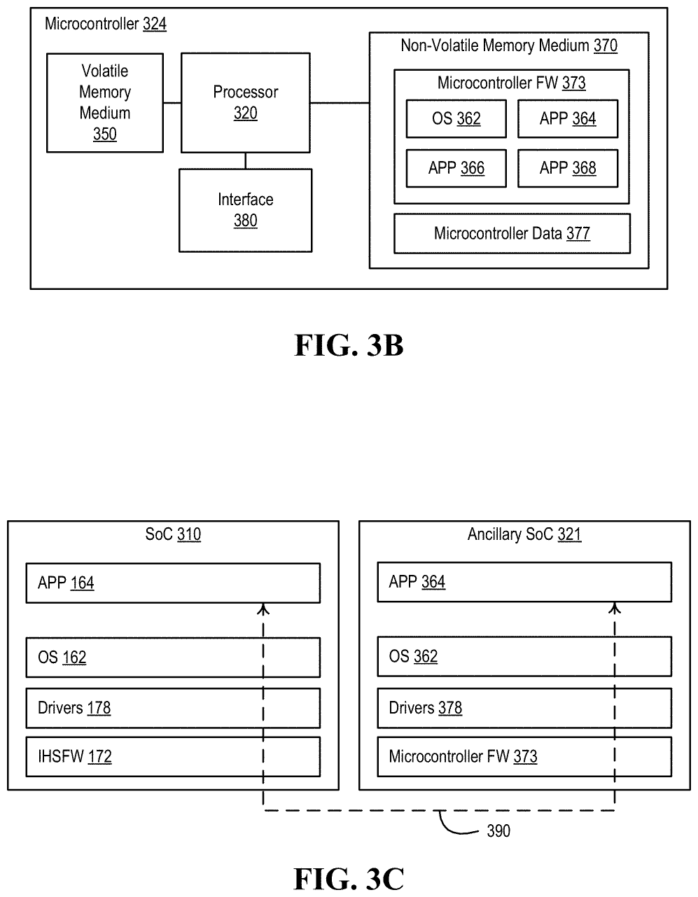

Turning now to FIG. 3A, an example of a logical representation of communications associated with an adaptive row is illustrated, according to one or more embodiments. In one or more embodiments, APPs 305 may communicate with a SoC 310. For example, APPs 305 may include one or more of APPs 164-168, among others. For instance, one or more of APPs 164-168 may communicate with a SoC 310. In one or more embodiments, SoC 310 may include processor 120, volatile memory medium 150, and an application programming interface (API) layer 312. For example, API layer 312 may be utilized in communicating with an ancillary SoC 321. For instance, API layer 312 may include processor instructions (e.g., processor instructions for processor 120), which may implement at least a portion of one or more systems, at least a portion of one or more flowcharts, at least a portion of one or more methods, and/or at least a portion of one or more processes described herein. In one or more embodiments, adaptive row 194 may include SoC 321. In one or more embodiments, EC 130 may communicate with SoC 310. In one or more embodiments, OS 162 may communicate with SoC 310.

In one or more embodiments, SoC 310 may communicate with ancillary SoC 321. In one example, SoC 321 may include a microcontroller 324. In a second example, SoC 321 may include subsystems 330. In one instance, subsystems 330 may include a display subsystem 332, which may control a display of adaptive row 194. In a second instance, subsystems 330 may include a controls subsystem 334. In a third instance, subsystems 330 may include a power subsystem 336, which may control power associated with adaptive row 194. In a fourth instance, subsystems 330 may include a gestures subsystem 338, which may receive user input gestures from a user of adaptive row 194. In another instance, subsystems 330 may include a haptics subsystem 340, which may provide haptic feedback to a user of adaptive row 194. In another example, SoC 321 may include an API layer 322, which may be utilized in communicating with SoC 310. For instance, API layer 322 may include processor instructions (e.g., processor instructions for a process of microcontroller 324), which may implement at least a portion of one or more systems, at least a portion of one or more flowcharts, at least a portion of one or more methods, and/or at least a portion of one or more processes described herein. In one or more embodiments, adaptive row 194 may include SoC 321.

Turning now to FIG. 3B, an example of a microcontroller is illustrated, according to one or more embodiments. As shown, microcontroller 324 may include a processor 320, a volatile memory medium 350, a non-volatile memory medium 370, and an interface 380. As illustrated, non-volatile memory medium 370 may include a microcontroller FW 373, which may include an OS 362 and APPs 364-368, and may include microcontroller data 377. In one example, OS 362 may be or include a real-time operating system (RTOS). For instance, the RTOS may be or include FreeRTOS, OpenRTOS, SafeRTOS, QNX, ThreadX, VxWorks, NuttX, TI-RTOS, eCos, MicroC/OS, or Zephyr, among others. In another example, OS 362 may be or include a POSIX compliant operating system.

In one or more embodiments, interface 380 may include circuitry that enables communicatively coupling to one or more devices. In one example, interface 380 may include circuitry that enables communicatively coupling to one or more buses. For instance, the one or more buses may include one or more buses described herein, among others. In a second example, interface 380 may include circuitry that enables one or more interrupt signals to be received. In one instance, interface 380 may include GPIO circuitry, and the GPIO circuitry may enable one or more interrupt signals to be received and/or provided via at least one interrupt line. In another instance, interface 380 may include GPIO circuitry that may enable microcontroller 324 to provide and/or receive signals associated with other circuitry. In a third example, interface 380 may include circuitry that enables communicatively coupling to one or more networks. In another example, interface 380 may include a network interface.

In one or more embodiments, one or more of OS 362 and APPs 364-368 may include processor instructions executable by processor 320. In one example, processor 320 may execute processor instructions of one or more of OS 362 and APPs 364-368 via non-volatile memory medium 370. In another example, one or more portions of the processor instructions of the one or more of OS 362 and APPs 364-368 may be transferred to volatile memory medium 350, and processor 320 may execute the one or more portions of the processor instructions of the one or more of OS 362 and APPs 364-368 via volatile memory medium 350. In one or more embodiments, processor 320 may execute instructions in accordance with at least a portion of one or more systems, at least a portion of one or more flowcharts, one or more methods, and/or at least a portion of one or more processes described herein. For example, non-volatile memory medium 370 and/or volatile memory medium 350 may store instructions that may be executable in accordance with at least a portion of one or more systems, at least a portion of one or more flowcharts, at least a portion of one or more methods, and/or at least a portion of one or more processes described herein. In one or more embodiments, processor 320 may execute instructions in accordance with at least a portion of one or more of systems, flowcharts, at least a portion of one or more methods, and/or at least a portion of one or more processes described herein. For example, non-volatile memory medium 370 and/or volatile memory medium 350 may store instructions that may be executable in accordance with at least a portion of one or more of systems, at least a portion of one or more flowcharts, at least a portion of one or more methods, and/or at least a portion of one or more processes described herein. In one or more embodiments, processor 320 may utilize microcontroller data 377. In one example, processor 320 may utilize microcontroller data 377 via non-volatile memory medium 370. In another example, one or more portions of microcontroller data 377 may be transferred to volatile memory medium 350, and processor 320 may utilize microcontroller data 377 via volatile memory medium 350.

Turning now to FIG. 3C, an example of software stacks is illustrated, according to one or more embodiments. In one or more embodiments, APP 164 and APP 364 may communicate with each other. For example, dashed line 390 may represent communications between APP 164 and APP 364. In one or more embodiments, communications between APP 164 and APP 364 may occur via elements of SoC 310 and elements of SoC 321. For example, communications between APP 164 and APP 364 may occur via elements of SoC 310 and elements of SoC 321 that intersect dashed line 390. For instance, SoC 310 and SoC 321 may communicate with each other via two software stacks. As an example, a first software stack of the two software stacks may include APP 164, OS 162, drivers 178, and IHSFW 172, among others. As another example, a second software stack of the two software stacks may include APP 362, OS 362, drivers 378, and microcontroller FW 373, among others.

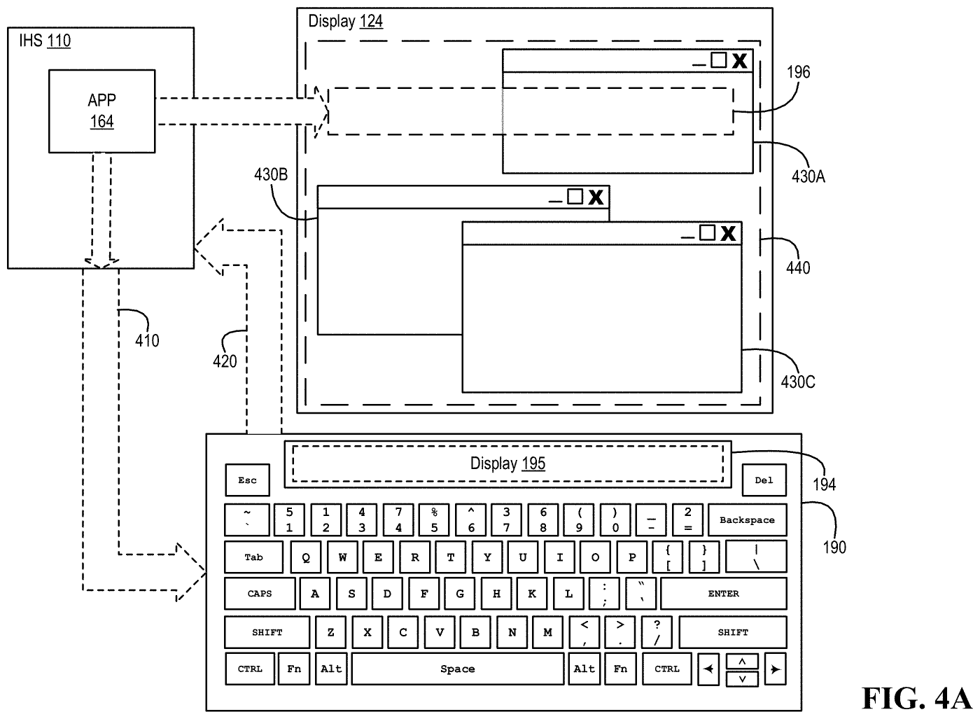

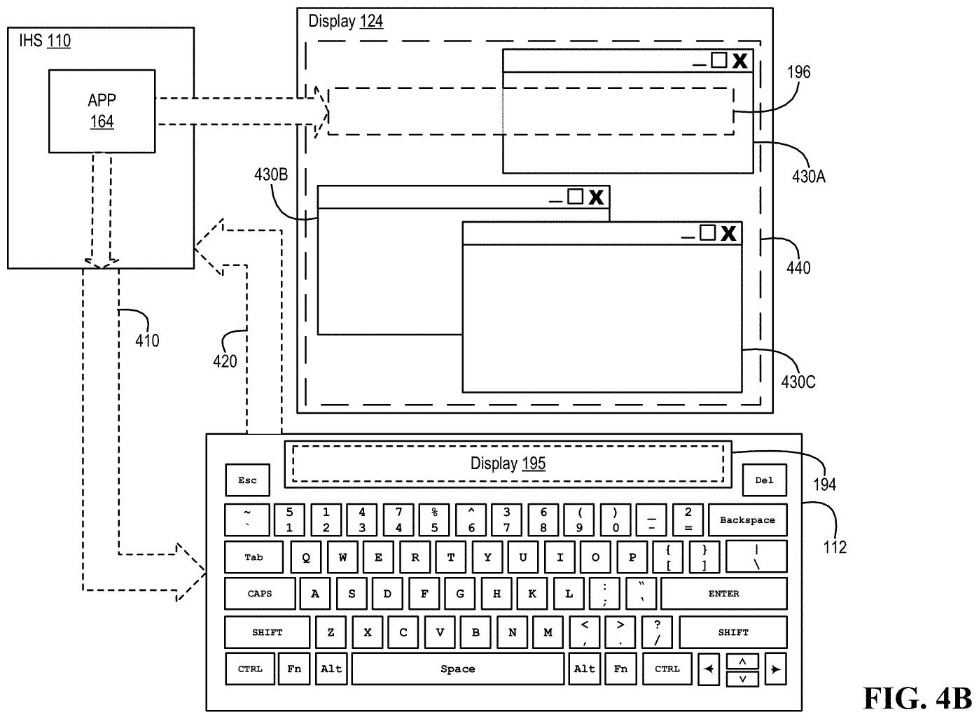

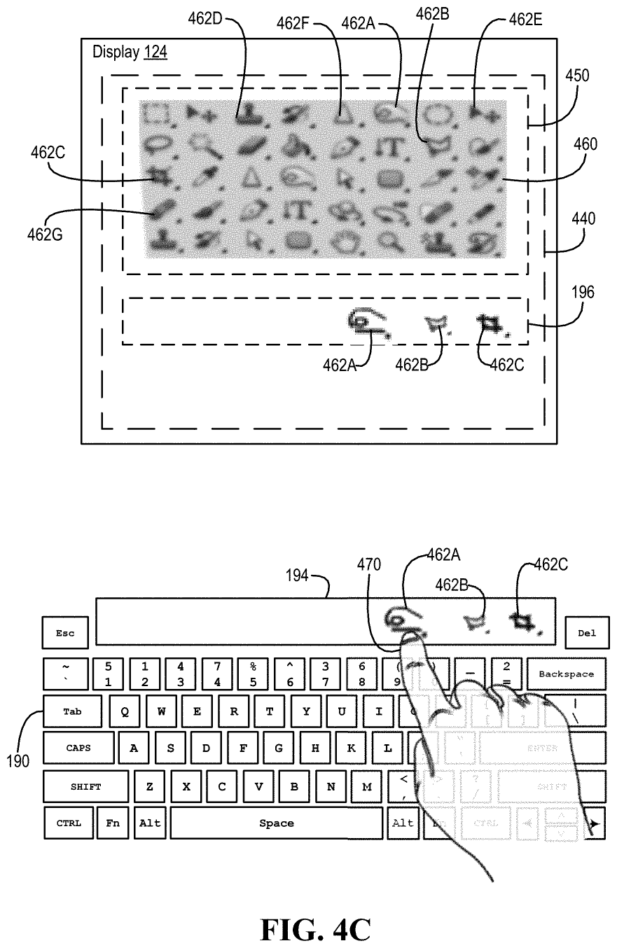

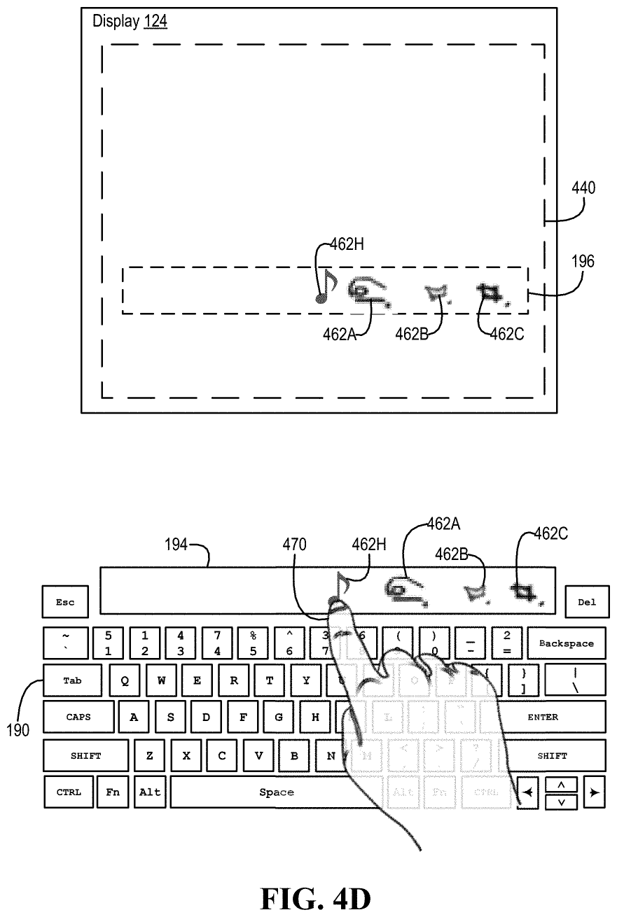

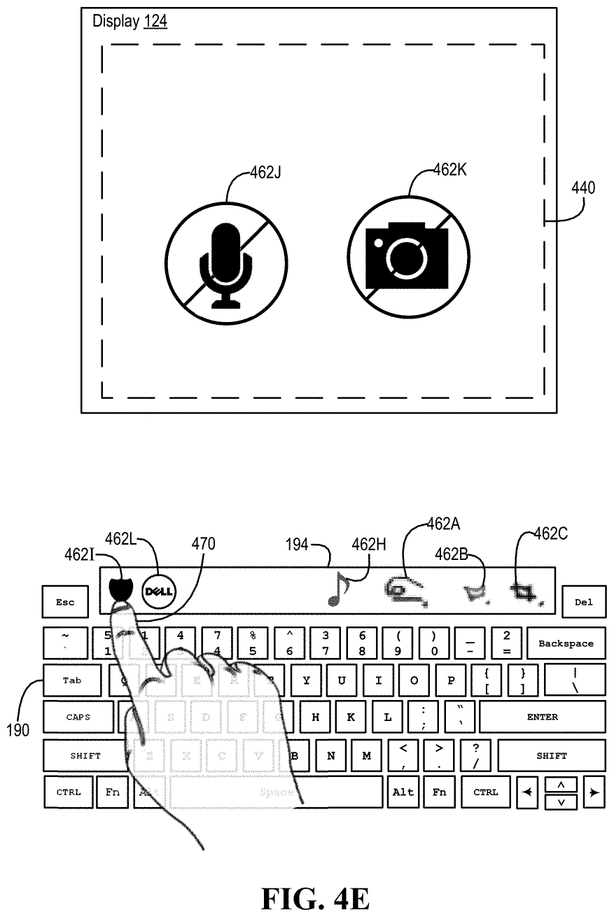

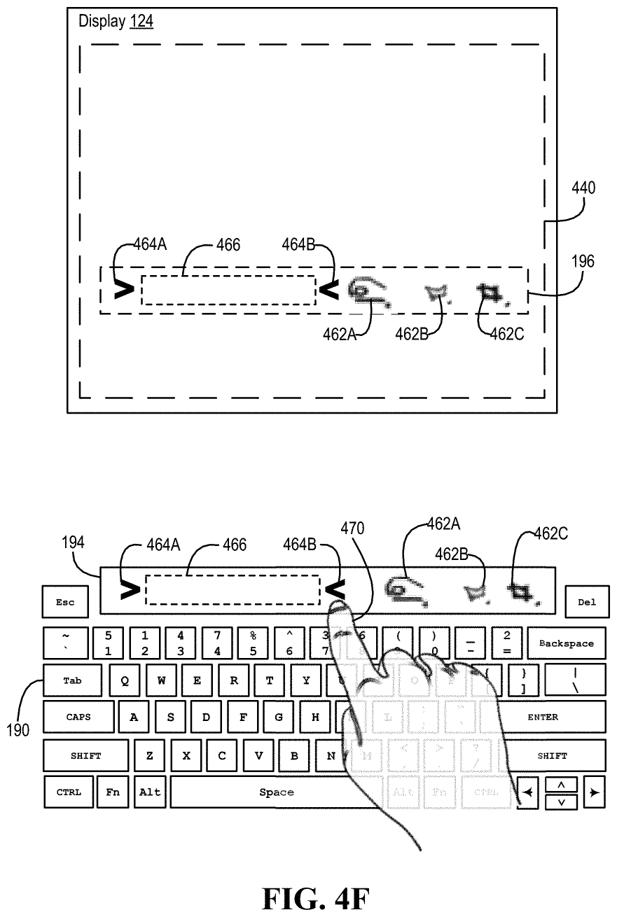

Turning now to FIGS. 4A and 4B, an example of utilizing an adaptive row is illustrated, according to one or more embodiments. In one or more embodiments, keyboard 190 may include adaptive row 194, as shown in FIG. 4A. In one or more embodiments, chassis 112 may include adaptive row 194, as shown in FIG. 4B. In one or more embodiments, adaptive row 194 may include a display 195. For example, display 195 may be or may include a touch screen. In one or more embodiments, display 195 may be communicatively coupled to microcontroller 324. For example, display 195 may be communicatively coupled to processor 320. For instance, display 195 may be communicatively coupled to processor 320 via interface 380.

In one or more embodiments, an application may communicate with keyboard 190. For example, APP 164 may communicate with keyboard 190. For instance, APP 164 may communicate with keyboard 190 via a coupling 410. As one example, coupling 410 may be or may include a wired coupling. For instance, coupling 410 may be or may include a USB coupling. As another example, coupling 410 may be or may include a wireless coupling. In one or more embodiments, an application may communicate with adaptive row 194. For example, APP 164 may communicate with adaptive row 194. For instance, APP 164 may communicate with adaptive row 194 via a coupling 410. As one example, coupling 410 may be or may include a wired coupling. For instance, coupling 410 may be or may include a USB coupling. As another example, coupling 410 may be or may include a wireless coupling.

In one or more embodiments, the application may control OSD 196. For example, APP 164 may control OSD 196. In one instance, APP 164 may display one or more images and/or one or more graphic via OSD 196. In another instance, APP 164 may receive user input via OSD 196. In one or more embodiments, keyboard 190 may be communicatively coupled to IHS 110 via a coupling 420. In one example, coupling 420 may be or may include a wired coupling. For instance, coupling 420 may be or may include a USB coupling. In another example, coupling 420 may be or may include a wireless coupling. In one or more embodiments, keyboard 190 may provide one or more keyboard events to IHS 110 via coupling 420. For example, keyboard 190 may provide one or more hardware events to IHS 110 via coupling 420. In one or more embodiments, adaptive row 194 may be communicatively coupled to IHS 110 via coupling 420. In one example, coupling 420 may be or may include a wired coupling. For instance, coupling 420 may be or may include a USB coupling. In another example, coupling 420 may be or may include a wireless coupling. In one or more embodiments, adaptive row 194 may provide one or more keyboard events to IHS 110 via coupling 420. For example, adaptive row 194 may provide one or more hardware events to IHS 110 via coupling 420.

In one or more embodiments, coupling 410 and coupling 420 may be combined into a single coupling, which may provide one or more structures and/or one or more functionalities of coupling 410 and coupling 420. In one example, coupling 410 and coupling 420 may be combined into a single wired coupling, which may provide one or more structures and/or one or more functionalities of coupling 410 and coupling 420. Although coupling 410 and coupling 420 may be combined into a single wired coupling, the single wired coupling may include multiple conductors, for instance. In a second example, coupling 410 and coupling 420 may be combined into a single coupling, which may be a single coupling of a composite device. In one instance, the composite device may provide and/or receive data associated with multiple devices, even though the composite device may utilize the single coupling. In another instance, the composite device may provide and/or receive data associated with multiple logical devices, in which each of the multiple logical devices may utilize the single coupling. In another example, coupling 410 and coupling 420 may be combined into a single wireless coupling, which may provide one or more structures and/or one or more functionalities of coupling 410 and coupling 420.

In one or more embodiments, APP 164 may provide first information to keyboard 190. In one example, APP 164 may provide the first information to keyboard 190 in response to receiving user input via OSD 196. In another example, APP 164 may provide the first information to keyboard 190 in response to an event (e.g., a calendar event, a timer event, an OS event, etc.). For instance, keyboard 190 may receive the first information from APP 164 via coupling 410. In one or more embodiments, keyboard 190 may process the first information from APP 164. For example, keyboard 190 may provide second information to IHS 110 based at least on processing the first information from APP 164. For instance, keyboard 190 may provide the second information to IHS 110 via coupling 420. As an example, the second information may include keyboard information. In one or more embodiments, the second information may include an event. For example, the event may be or may include a hardware event. For instance, the hardware event may be or include a keyboard event. In one or more embodiments, IHS 110 may provide the second information to an application that has focus.

In one or more embodiments, APP 164 may provide first information to adaptive row 194. In one example, APP 164 may provide the first information to adaptive row 194 in response to receiving user input via OSD 196. In another example, APP 164 may provide the first information to adaptive row 194 in response to an event (e.g., a calendar event, a timer event, an OS event, etc.). For instance, adaptive row 194 may receive the first information from APP 164 via coupling 410. In one or more embodiments, keyboard 190 may process the first information from APP 164. For example, adaptive row 194 may provide second information to IHS 110 based at least on processing the first information from APP 164. For instance, adaptive row 194 may provide the second information to IHS 110 via coupling 420. As an example, the second information may include keyboard information. In one or more embodiments, the second information may include an event. For example, the event may be or may include a hardware event. For instance, the hardware event may be or include a keyboard event. In one or more embodiments, IHS 110 may provide the second information to an application that has focus.

In one or more embodiments, focus may indicate an act of selecting an element of a GUI. For example, focus may indicate an act of selecting a window of windows 430A-430C of a GUI 440. In one or more embodiments, focus may be a selected element of a GUI. For example, focus may be a selected window of windows 430A-430C of GUI 440. In one or more embodiments, a window of a GUI may be associated with an application. In one example, window 430A of GUI 440 may be associated with APP 166. For instance, when window 430A has focus, APP 166 may have focus (e.g., user input focus). In another example, windows 430B and 430C of GUI 440 may be associated with APP 168. In one instance, when window 430B has focus, APP 168 may have focus. In another instance, when window 430C has focus, APP 168 may have focus (e.g., user input focus).

In one or more embodiments, when a window has focus, an application associated with the window may have focus (e.g., user input focus), and input from keyboard 190 and/or input from a pointing device 114 may be provided to the application that has the focus (e.g., the user input focus). In one example, when window 430A has focus, APP 166 may have focus (e.g., user input focus), and the second information may be provided to APP 166. In a second example, when window 430B has focus, APP 168 may have focus (e.g., user input focus), and the second information may be provided to APP 168. In another example, when window 430C has focus, APP 168 may have focus, and the second information may be provided to APP 168.

In one or more embodiments, focus may be click to focus. For example, a window may not have focus until a user selects the window. For instance, the user may select the window with a click of a mouse, a click of a touchpad, a tap on a touchpad, etc. In one or more embodiments, when click to focus is utilized, a window may maintain focus even if a pointer is not on or within bounds of the window. In one or more embodiments, focus may follow a pointer. For example, a window may have focus when a pointer is on or within bounds of the window. In one or more embodiments, a focused window may not necessarily be raised. For example, one or more portions of the window may remain below one or more other windows.

In one or more embodiments, IHS 110 providing the second information to an application that has focus may include IHS 110 providing the second information to an operating system, which may provide the second information to the application. In one example, IHS 110 providing the second information to APP 166 that has focus (e.g., user input focus) may include IHS 110 providing the second information to OS 162, which may provide the second information to APP 166. For instance, OS 162 may provide, to APP 166, the second information as keyboard information. In another example, IHS 110 providing the second information to APP 168 that has focus (e.g., user input focus) may include IHS 110 providing the second information to OS 162, which may provide the second information to APP 168. For instance, OS 162 may provide, to APP 168, the second information as keyboard information.

Turning now to FIG. 4C, a second example of utilizing an adaptive row is illustrated, according to one or more embodiments. In one or more embodiments, display 124 may display GUI 440. In one example, GUI 440 may display a display area 450. For instance, display area 450 may display a palette 460. In one or more embodiments, display area 450 may be associated with an application. In another example, GUI 440 may display OSD 196. Although not specifically illustrated, display area 450 may be displayed via a window 430, according to one or more embodiments. In one or more embodiments, palette 460 may be associated with an application. Although not specifically illustrated, palette 460 may be displayed via a window 430 of an application, according to one or more embodiments.

In one or more embodiments, OSD 196 may be configured with one or more icons 460. In one example, an icon 462 may be selected from palette 460 and dragged to OSD 196. In another example, an icon 462 may be selected from palette 460 and copied to OSD 196. As illustrated, palette 460 may include icons 462A-462G, among others. As shown, OSD 196 may be configured with icons 462A-462C. In one or more embodiments, icons 462A-462C may be displayed via adaptive row 194. For example, icons 462A-462C may be mirrored in adaptive row 194.

In one or more embodiments, a user may select an icon 462 in adaptive row 194. For example, the user may utilize a digit 470 (e.g., a finger) to select an icon 462 in adaptive row 194. In one or more embodiments, adaptive row 194 may include a touch screen, which may display one or more icons 462 and may receive user input selecting an icon of the one or more icons 462. For example, the touch screen may display icons 462A-462C. For instance, the touch screen may receive user input that selects an icon of icons 462A-462C. In one or more embodiments, adaptive row 194 may provide haptic feedback to the user. For example, adaptive row 194 may provide vibrations to digit 470 when an icon of icons 462A-462C is selected.

Turning now to FIG. 4D, a third example of utilizing an adaptive row is illustrated, according to one or more embodiments. In one or more embodiments, adaptive row 194 may be swiped. For example, an action, a method, and/or a process may be performed in response to adaptive row 194 being swiped. In one instance, when adaptive row 194 is swiped right, adaptive row 194 may provide information to processor 120 that indicates that a window may be scrolled upwards. In another instance, when adaptive row 194 is swiped left, adaptive row 194 may provide information to processor 120 that indicates that a window may be scrolled downwards. In one or more embodiments, an icon 462 in adaptive row 194 may be selected and swiped. For example, an action, a method, and/or a process may be performed in response to an icon 462 in adaptive row 194 being selected and swiped. In one instance, when an icon 462H is selected and swiped right, adaptive row 194 may provide information to processor 120 that indicates that a volume of sound (e.g., a sound pressure level) may be increased. In another instance, when an icon 462H is selected and swiped left, adaptive row 194 may provide information to processor 120 that indicates that a volume of sound (e.g., a sound pressure level) may be decreased.

Turning now to FIG. 4E, a fourth example of utilizing an adaptive row is illustrated, according to one or more embodiments. In one or more embodiments, one or more actions, one or more methods, and/or one or more processes may be performed in response to an icon 462 in adaptive row 194 being selected. In one example, when icon 462I is selected, adaptive row 194 may provide information to processor 120 that indicates that a microphone associated with IHS 110 may be muted and/or a camera associated with IHS 110 may be turned off or prevented from capturing images and/or video. In one instance, an icon 462J may be displayed via GUI 440, which may indicate that the microphone associated with IHS 110 has been muted. In another instance, an icon 462K may be displayed via GUI 440, which may indicate that the camera associated with IHS 110 has been turned off. In one or more embodiments, OSD 194 may not be displayed. For example, OSD 194 may not be displayed via GUI 440. In a second example, when icon 462L is selected, adaptive row 194 may provide information to processor 120 that indicates that a system configuration application may be executed and/or a system configuration window may be displayed. In another example, when an icon 462L is selected and swiped right, adaptive row 194 may provide information to processor 120 that indicates that IHS 110 should be secured and/or locked. For instance, securing and/or locking IHS 110 may include securing and/or locking IHS 110 a GUI associated with OS 162.

Turning now to FIG. 4F, another example of utilizing an adaptive row is illustrated, according to one or more embodiments. In one or more embodiments, multiple menus may be selected via icons 464A and 464B. For example, the multiple menus may be displayed via an adaptive row portion 466. For instance, adaptive row portion 466 may display one or more icons 462. In one or more embodiments, OSD 196 may display icons 464A and 464B, adaptive row portion 466, and the multiple menus selected via icons 464A and 464B. In one or more embodiments, icons 464A and 464B may include chevrons. In one example, the chevrons may indicate one or more directions in selecting a menu from multiple menus. For instance, the chevrons may indicate one or more directions in selecting a menu from a circular queue of menus. In another example, the chevrons may indicate one or more directions in selecting a menu from a hierarchy of menus.

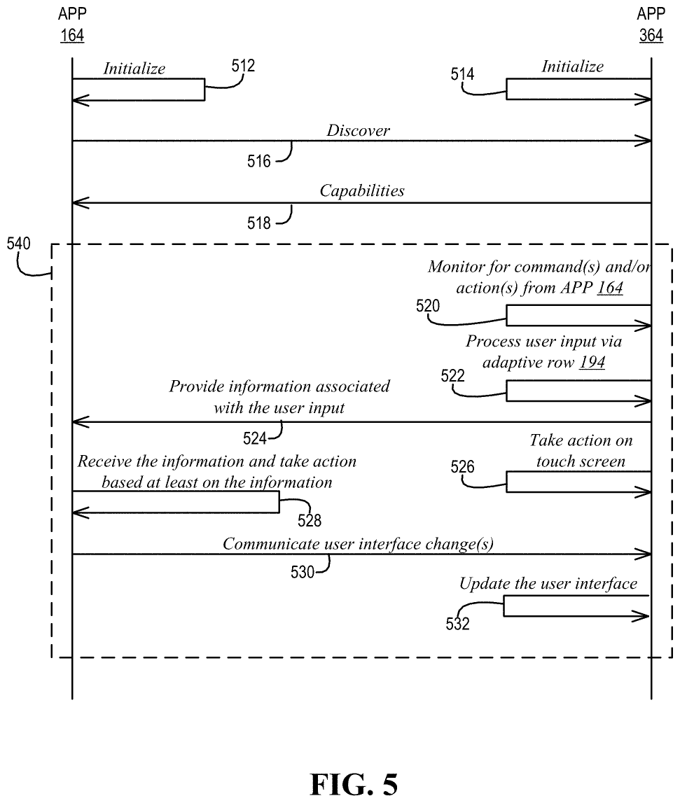

Turning now to FIG. 5, an example of a sequence diagram of utilizing an adaptive row is illustrated, according to one or more embodiments. At 512, APP 164 may initialize. At 514, APP 364 may initialize. At 516, APP 164 discover one or more capabilities of APP 364. For example, APP 164 discover one or more capabilities of adaptive row 194. At 518, APP 364 may provide the one or more capabilities of APP 364 to APP 164. For example, APP 364 may provide the one or more capabilities of adaptive row 194 to APP 164. In one or more embodiments, APP 164 may configure one or more rules based at least on the one or more capabilities of APP 364 and/or based at least on the one or more capabilities of adaptive row 194. In one or more embodiments, APP 164 may configure one or more action modes based at least on the one or more capabilities of APP 364 and/or based at least on the one or more capabilities of adaptive row 194.

At 520, APP 364 may monitor for one or more commands and/or one or more actions from APP 164. At 522, APP 364 may process user input via adaptive row 194. At 524, APP 364 may provide information associated with the user input to APP 164. At 526, APP 364 may take action on a touch screen of adaptive row 194. For example, APP 364 may take action on a touch screen of adaptive row 194 based at least on the user input via adaptive row 194. At 528, APP 164 may receive the information and take action based at least on the information. In one example, APP 164 may process the information and may take action based at least on processing the information. In another example, APP 164 may apply one or more rules to the information and may take action based at least on applying the one or more rules to the information. At 530, APP 164 may communicate one or more user interface changes to APP 364. At 532, APP 364 may update the user interface. In one or more embodiments, the sequence may proceed to 520. For example, a loop 540 may include elements 520-532.

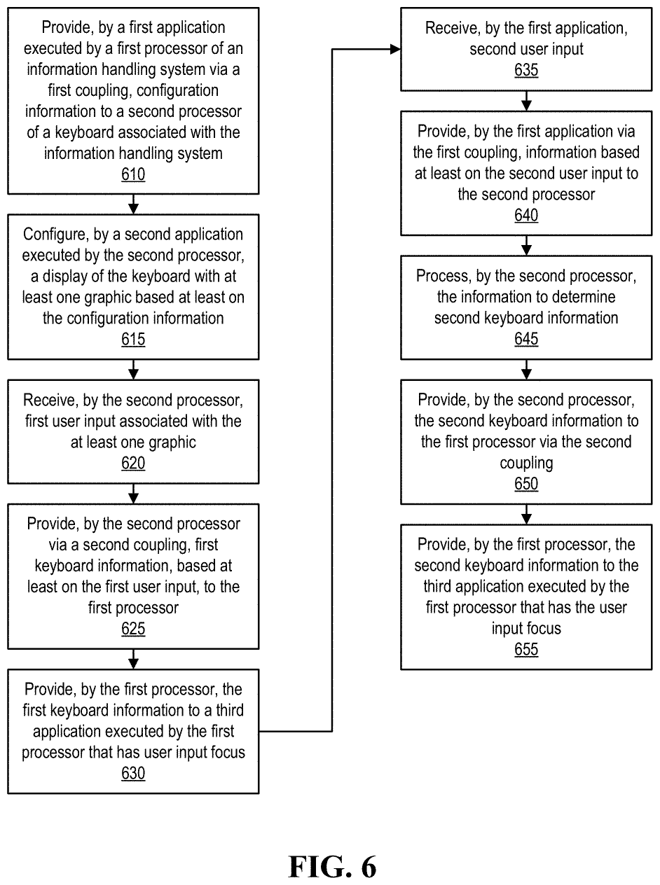

Turning now to FIG. 6, an example of a method of utilizing an adaptive row with an information handling system is illustrated, according to one or more embodiments. At 610, a first application executed by a first processor of an information handling system may provide, via a first coupling, configuration information to a second processor of a keyboard associated with the information handling system. For example, APP 164, executed by processor 120, may provide configuration information to processor 320 of keyboard 190 associated with IHS 110 via coupling 410. In one or more embodiments, the configuration information may include a JavaScript Object Notation (JSON) format. For example, the configuration information may include one or more data structures, one or more objects (e.g., object oriented programming objects), one or more graphics, one or more icons, and/or instructions, among others. In one or more embodiments, the configuration information may synchronize hardware and software (e.g., one or more applications). In one or more embodiments, the configuration information may program adaptive row 194. For example, a menuing structure may be utilized to create, modify, and/or program the configuration information.

In one or more embodiments, the first coupling may include at least one of a first I²C bus, a first SPI bus, a first LPC bus, a first eSPI bus, a first USB, and a first SMBus, among others. In one or more embodiments, the first application may not have user input focus. For example, the first application may not have user input focus while one or more of method elements 610-655 are performed. For instance, the first application may not have user input focus while any of method elements 610-655 are performed. In one or more embodiments, the information handling system may include the keyboard. For example, IHS 110 may include keyboard 190. In one or more embodiments, the information handling system may be at least one of a laptop-type information handling system and a notebook-type information handling system. For example, IHS 110 may be at least one of a laptop-type information handling system and a notebook-type information handling system. In one or more embodiments, the information handling system may not include the keyboard. For example, IHS 110 may not include keyboard 190. For instance, keyboard 190 may be external to IHS 110. As an example, keyboard 190 may be communicatively coupled to IHS 110.

At 615, a second application executed by the second processor may configure a display of the keyboard with at least one graphic based at least on the configuration information. For example, APP 364, executed by processor 320, may configure display 195 of keyboard 190 with at least one graphic based at least on the configuration information. For instance, a graphic may be or may include an icon 462. As an example, APP 364, executed by processor 320, may configure display 195 of keyboard 190 with one or more of icons 462A-462I and 462L based at least on the configuration information.

At 620, the second processor may receive first user input associated with the at least one graphic. For example, processor 320 may receive first user input associated with the at least one graphic. For instance, processor 320 may receive first user input associated with at least one icon 462. In one or more embodiments, the first user input may include at least one of a selection of the at least one graphic and a swipe of the at least one graphic. For example, the first user input may include at least one of a selection of the at least one icon 462 and a swipe of the at least one icon 462. In one instance, display 195 may include a touch screen, which may be utilized to detect the at least one of the selection of the at least one graphic and the swipe of the at least one graphic. In another instance, display 195 may include a touch screen, which may be utilized to detect the at least one of the selection of the at least one icon 462 and the swipe of the at least one icon 462. In one or more embodiments, the selection of the at least one icon 462 may include an actuation of the at least one icon 462 with digit 470. In one example, the actuation of the at least one icon 462 with digit 470 may include digit 470 contacting a portion of display 195 associated with the at least one icon 462 for an amount of time transpiring. For instance, contacting the portion of display 195 associated with the at least one icon 462 for the amount of time transpiring may include digit 470 providing pressure to the portion of display 195 associated with the at least one icon 462 for the amount of time transpiring. In another example, the actuation of the at least one icon 462 with digit 470 may include digit 470 tapping a portion of display 195 associated with the at least one icon 462.

At 625, the second processor may provide, via a second coupling, first keyboard information, based at least on the first user input, to the first processor. For example, processor 320 may provide, via coupling 420, first keyboard information to processor 120. In one or more embodiments, the second coupling may include at least one of a second I²C bus, a second SPI bus, a second LPC bus, a second eSPI bus, a second USB, and a second SMBus, among others. In one or more embodiments, the second coupling may be different from the first coupling. In one or more embodiments, the first coupling and the second coupling may be combined as a single coupling. For example, coupling 410 and coupling 420 may be combined as a single coupling.

In one or more embodiments, a protocol may be utilized in providing keyboard information to processor 120. For example, the protocol, which may be utilized in providing keyboard information to processor 120, may include a human input device (HID) protocol. For instance, the HID protocol may include a report protocol. In one or more embodiments, the report protocol may utilize a report data structure, which may be utilized by processor 320 to provide information (e.g., keyboard information) to processor 120. For example, the report data structure may be utilized to convey a key press of keyboard 190. In one or more embodiments, a report data structure may be requested by processor 120. For example, a report data structure may be requested by processor 120 via an interrupt transfer. For instance, an interrupt transfer may occur once per an interval number of milliseconds. As an example, the interval number may be defined in an interrupt descriptor of keyboard 190.

In one or more embodiments, the report data structure may include a number of bytes. For example, the number of bytes of the report data structure may be eight bytes, among others. Although the number of bytes of the report data structure may be specified, not all the number of bytes of the report data structure may be utilized in providing data, according to one or more embodiments. For example, one or more of the number of bytes of the report data structure may include data that may be ignored by processor 120. For instance, a byte of the report data structure may include specific data that may be ignored by processor 120. As an example, a byte of the report data structure that may be ignored by processor 120 may include a specific bit configuration. In one or more embodiments, the report data structure may include one or more of modifier keys status, a reserved field, a first key press, a second key press, a third key press, a fourth key press, a fifth key press, and a sixth key press, among others. For example, the report data structure may include six simultaneous key presses of keys of keyboard 190. For instance, a key press may be represented via a USB scan code. In one or more embodiments, the modifier keys status may include one or more of a status of a left control key, a status of a left shift key, a status of a left alternate key, a status of a left GUI key (e.g., a left Windows key, a left super key, etc.), a status of a right control key, a status of a right shift key, a status of a right alternate key, and a status of a right GUI key (e.g., a right Windows key, a right super key, etc.), among others. In one or more embodiments, keyboard information provided to processor 120 may include a report data structure. In one or more embodiments, the first keyboard information may include a first report data structure that includes at least eleven key presses. For example, the first keyboard information may include a first report data structure that includes at least eleven simultaneous key presses.

At 630, the first processor may provide the first keyboard information to a third application executed by the first processor that has user input focus. For example, processor 120 may provide the first keyboard information to APP 166, executed by processor 120, that has user input focus. At 635, the first application may receive second user input. For example, APP 164 may receive second user input. For instance, APP 164 may receive the second user input via OSD 196. As an example, the second user input may include a selection of an icon 462 or an icon 464 displayed via OSD 196. At 640, the first application may provide, via the first coupling to the second processor, information based at least on the second user input. For example, APP 164 may provide, to processor 320 via coupling 410, information based at least on the second user input. In one or more embodiments, the information based at least on the second user input may indicate the selection of an icon 462 or an icon 464 displayed via OSD 196. In one or more embodiments, providing the information based at least on the second user input to the second processor may include providing the information to the second processor without providing the information to an operating system executing on the information handling system. For example, APP 164 may provide, to processor 320 via coupling 410, the information based at least on the second user input without providing the information based at least on the second user input to OS 162.

At 645, the second processor may process the information to determine second keyboard information. For example, processor 320 may process the information to determine second keyboard information. In one or more embodiments, the second keyboard information may include a second report data structure that includes at least eleven key presses. For example, the second keyboard information may include a second report data structure that includes at least eleven simultaneous key presses. In one or more embodiments, the second keyboard information may be different from the first keyboard information. For example, a first key press of the first keyboard information may be different from a second key press of the second keyboard information. For instance, at least one key press of the first keyboard information may be different from the second keyboard information.

At 650, the second processor may provide the second keyboard information to the first processor via the second coupling. For example, processor 320 may provide the second keyboard information to processor 120 via coupling 420. At 655, the first processor may provide the second keyboard information to the third application, executed by the first processor, that has the user input focus. For example, processor 120 may provide the second keyboard information to APP 166, executed by processor 120, that has the user input focus.

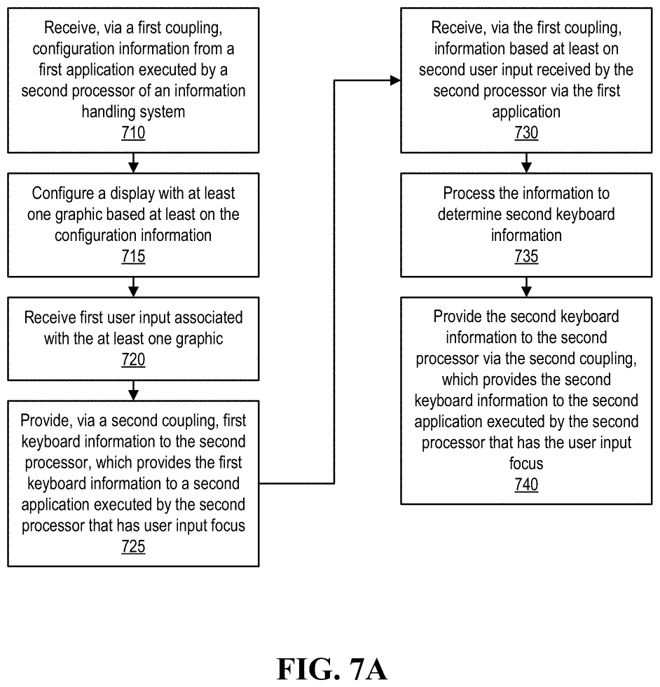

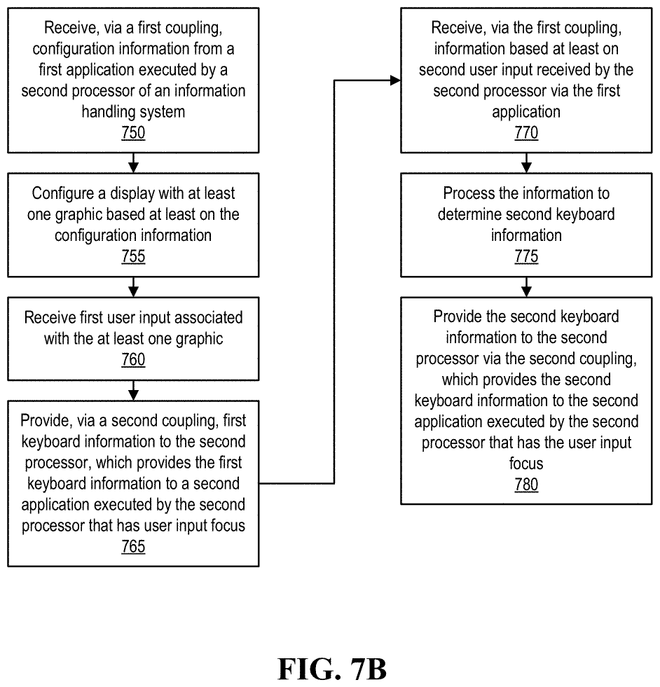

Turning now to FIG. 7A, an example of a method of operating a keyboard is illustrated, according to one or more embodiments. At 710, a first processor of a keyboard may receive, via a first coupling, configuration information from a first application executed by a second processor of an information handling system. For example, processor 320 of keyboard 190 may receive, via coupling 410, configuration information from APP 164 executed by processor 120 of IHS 110. In one or more embodiments, the configuration information may include a JSON format. For example, the configuration information may include one or more data structures, one or more objects (e.g., object oriented programming objects), one or more graphics, one or more icons, and/or instructions, among others. In one or more embodiments, the configuration information may synchronize hardware and software (e.g., one or more applications). In one or more embodiments, the configuration information may program adaptive row 194. For example, a menuing structure may be utilized to create, modify, and/or program the configuration information.

At 715, the first processor may configure a display of the keyboard with at least one graphic based at least on the configuration information. For example, processor 320 may configure display 195 of keyboard 190 with at least one graphic based at least on the configuration information. For instance, the at least one graphic may include at least one icon 462. As an example, processor 320 may configure display 195 of keyboard 190 with at least one icon 462 based at least on the configuration information.

At 720, the first processor may receive first user input associated with the at least one graphic. For example, processor 320 may receive first user input associated with the at least one graphic. For instance, processor 320 may receive first user input associated with the at least one icon 462. At 725, the first processor may provide, via a second coupling, first keyboard information to the second processor, which may provide the first keyboard information to a second application executed by the second processor that has user input focus. For example, processor 320 may provide, via coupling 420, first keyboard information to processor 120, which may provide the first keyboard information to APP 166, executed by processor 120, that has user input focus.

At 730, the first processor may receive, via the first coupling, information based at least on second user input received by the second processor via the first application. For example, processor 320 may receive, via the first coupling, information based at least on second user input received by processor 120 via APP 164. At 735, the first processor may process the information to determine second keyboard information. For example, processor 320 may process the information to determine second keyboard information. At 740, the first processor may provide the second keyboard information to the second processor via the second coupling, which provides the second keyboard information to the second application executed by the second processor that has the user input focus. For example, processor 320 may provide the second keyboard information to processor 120 via coupling 420, which may provide the second keyboard information to APP 166, executed processor 120, that has the user input focus.

Turning now to FIG. 7B, an example of a method of operating an adaptive row is illustrated, according to one or more embodiments. In one or more embodiments, an adaptive row may include: a first processor; a display communicatively coupled to the first processor; and a memory medium, coupled to the first processor, that stores instructions executable by the first processor, which when executed by the first processor, cause the adaptive row to perform method elements 750-780, among others. At 750, a first processor of the adaptive row may receive, via a first coupling, configuration information from a first application executed by a second processor of an information handling system. For example, processor 320 of adaptive row 194 may receive, via coupling 410, configuration information from APP 164 executed by processor 120 of IHS 110. In one or more embodiments, the configuration information may include a JSON format. For example, the configuration information may include one or more data structures, one or more objects (e.g., object oriented programming objects), one or more graphics, one or more icons, and/or instructions, among others. In one or more embodiments, the configuration information may synchronize hardware and software (e.g., one or more applications). In one or more embodiments, the configuration information may program adaptive row 194. For example, a menuing structure may be utilized to create, modify, and/or program the configuration information.

At 755, the first processor may configure a display of the adaptive row with at least one graphic based at least on the configuration information. For example, processor 320 may configure display 195 of adaptive row 194 with at least one graphic based at least on the configuration information. For instance, the at least one graphic may include at least one icon 462. As an example, processor 320 may configure display 195 of adaptive row 194 with at least one icon 462 based at least on the configuration information.

At 760, the first processor may receive first user input associated with the at least one graphic. For example, processor 320 may receive first user input associated with the at least one graphic. For instance, processor 320 may receive first user input associated with the at least one icon 462. At 765, the first processor may provide, via a second coupling, first keyboard information to the second processor, which may provide the first keyboard information to a second application executed by the second processor that has user input focus. For example, processor 320 may provide, via coupling 420, first keyboard information to processor 120, which may provide the first keyboard information to APP 166, executed by processor 120, that has user input focus.

At 770, the first processor may receive, via the first coupling, information based at least on second user input received by the second processor via the first application. For example, processor 320 may receive, via the first coupling, information based at least on second user input received by processor 120 via APP 164. At 775, the first processor may process the information to determine second keyboard information. For example, processor 320 may process the information to determine second keyboard information. At 780, the first processor may provide the second keyboard information to the second processor via the second coupling, which provides the second keyboard information to the second application executed by the second processor that has the user input focus. For example, processor 320 may provide the second keyboard information to processor 120 via coupling 420, which may provide the second keyboard information to APP 166, executed processor 120, that has the user input focus.

In one or more embodiments, one or more of the method and/or process elements and/or one or more portions of a method and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with at least a portion of one or more flowcharts, at least a portion of one or more systems, at least a portion of one or more methods, and/or at least a portion of one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. An information handling system, comprising:
a first processor;
a first display communicatively coupled to the first processor;
a first memory medium, communicatively coupled to the first processor, that stores a first application executable by the first processor and stores an operating system executable by the first processor; and
a keyboard communicatively coupled to the first processor;
wherein the keyboard includes a second processor, a second memory medium, communicatively coupled to the second processor, that stores a second application executable by the second processor, and a second display;
wherein when the first application is executed by the first processor, the first application causes the first processor to:
provide, via a first coupling, configuration information to the second processor;
wherein when the second application is executed by the second processor, the second application causes the second processor to:
configure, based at least on the configuration information, the second display with at least one graphic;
receive first user input associated with the at least one graphic; and
provide, via a second coupling, first keyboard information, based at least on the first user input, to the first processor;
wherein the first application further causes the first processor to:
provide the first keyboard information to a third application executed by the first processor that has user input focus;
receive, via the first display, second user input; and
provide, via the first coupling, information based at least on the second user input to the second processor without providing the information to the operating system executable by the first processor;
wherein the second application further causes the second processor to:
process the information to determine second keyboard information, which includes a report data structure that includes multiple simultaneous key presses; and
provide the second keyboard information to the first processor via the second coupling; and
wherein the operating system causes the first processor to:
provide the second keyboard information to the third application executed by the first processor that has the user input focus.

2. The information handling system of claim 1, wherein the first application does not have the user input focus.

3. (canceled)

4. The information handling system of claim 1, wherein the second coupling is different from the first coupling.

5. The information handling system of claim 1, wherein the first user input includes at least one of a selection of the at least one graphic and a swipe of the at least one graphic.

6. The information handling system of claim 1, wherein the information handling system is at least one of a laptop-type information handling system and a notebook-type information handling system.

7. The information handling system of claim 1,
wherein the first coupling includes at least one of a first inter-integrated circuit (I²C) bus, a first serial peripheral interface (SPI) bus, a first low pin count (LPC) bus, a first enhanced serial peripheral interface (eSPI) bus, and a first universal serial bus (USB); and
wherein the second coupling includes at least one of a second I²C bus, a second SPI bus, a second LPC bus, a second eSPI bus, and a second USB.

8. A method, comprising:
providing, by a first application executed by a first processor of an information handling system via a first coupling, configuration information to a second processor of a keyboard associated with the information handling system;
configuring, by a second application executed by the second processor, a display of the keyboard with at least one graphic based at least on the configuration information;
receiving, by the second processor, first user input associated with the at least one graphic;
providing, by the second processor via a second coupling, first keyboard information, based at least on the first user input, to the first processor;
providing, by the first processor, the first keyboard information to a third application executed by the first processor that has user input focus;
receiving, by the first application, second user input via a display of the information handling system;
providing, by the first application via the first coupling, information based at least on the second user input to the second processor without providing the information to an operating system executing on the information handling system;
processing, by the second processor, the information to determine second keyboard information, which includes a report data structure that includes multiple simultaneous key presses;
providing, by the second processor, the second keyboard information to the first processor via the second coupling; and
providing, by the first processor via the operating system, the second keyboard information to the third application executed by the first processor that has the user input focus.

9. The method of claim 8, wherein the first application does not have the user input focus.

10. (canceled)

11. The method of claim 8, wherein the second coupling is different from the first coupling.

12. The method of claim 8, wherein the information handling system includes the keyboard.

13. The method of claim 12, wherein the information handling system is at least one of a laptop-type information handling system and a notebook-type information handling system.

14. The method of claim 8,
wherein the first coupling includes at least one of a first inter-integrated circuit (I²C) bus, a first serial peripheral interface (SPI) bus, a first low pin count (LPC) bus, a first enhanced serial peripheral interface (eSPI) bus, and a first universal serial bus (USB); and
wherein the second coupling includes at least one of a second I²C bus, a second SPI bus, a second LPC bus, a second eSPI bus, and a second USB.

15. A keyboard, comprising:
a first processor;
a display communicatively coupled to the first processor; and
a memory medium, coupled to the first processor, that stores instructions executable by the first processor, which when executed by the first processor, cause the keyboard to:
receive, via a first coupling, configuration information from a first application executed by a second processor of an information handling system;
configure the display with at least one graphic based at least on the configuration information;
receive first user input associated with the at least one graphic;
provide, via a second coupling, first keyboard information to the second processor, which provides the first keyboard information to a second application executed by the second processor that has user input focus;
receive, via the first coupling, information based at least on second user input received by the second processor via the first application;
process the information to determine second keyboard information, which includes a report data structure that includes multiple simultaneous key presses; and
provide the second keyboard information to the second processor via the second coupling, which provides the second keyboard information to the second application executed by the second processor that has the user input focus.

16. The keyboard of claim 15, wherein the second coupling is different from the first coupling.

17. The keyboard of claim 15, wherein the first user input includes at least one of a selection of the at least one graphic and a swipe of the at least one graphic.

18. The keyboard of claim 12,
wherein the information handling system includes the keyboard; and
wherein the information handling system is at least one of a laptop-type information handling system and a notebook-type information handling system.

19. The keyboard of claim 15,
wherein the first coupling includes at least one of a first inter-integrated circuit (I²C) bus, a first serial peripheral interface (SPI) bus, a first low pin count (LPC) bus, a first enhanced serial peripheral interface (eSPI) bus, and a first universal serial bus (USB); and
wherein the second coupling includes at least one of a second I²C bus, a second SPI bus, a second LPC bus, a second eSPI bus, and a second USB.

20. The keyboard of claim 15, further comprising:
a microcontroller;
wherein the microcontroller includes the first processor and the memory medium.

21. The information handling system of claim 1, wherein the second keyboard information includes multiple universal serial bus (USB) scan codes that correspond to the multiple simultaneous key presses.

22. The method of claim 8, wherein the second keyboard information includes multiple universal serial bus (USB) scan codes that correspond to the multiple simultaneous key presses.
